(19) United States
(12) Patent Application Publication
(10) Pub. No.: US 2026/0202953 A1
(43) Pub. Date: Jul. 16, 2026

(54) INFORMATION PROCESSING METHOD, SESSION PROCESSING METHOD, APPARATUS, DEVICE AND MEDIUM

(71) Applicant: Beijing Zitiao Network Technology Co., Ltd., Beijing (CN)

(72) Inventors: Yueying WANG, Beijing (CN); Xin XIE, Singapore (SG); Bowen SHEN, Beijing (CN); Yongqiang ZHAO, Beijing (CN); Xin SUN, Beijing (CN); Jie WEI, Beijing (CN)

(21) Appl. No.: 18/867,793

(22) PCT Filed: May 25, 2023
(86) PCT No.: PCT/CN2023/096191

§ 371 Date: Nov. 20, 2024

(30) Foreign Application Priority Data
May 30, 2022 (CN) 202210600706.6
May 30, 2022 (CN) 202210603057.5

(51) Int. Cl. G06F 3/04847; G06F 3/0482; G06F 3/0483

(52) U.S. Cl. CPC G06F 3/04847; G06F 3/0483; G06F 3/0482

(57) ABSTRACT

Provided in the present disclosure are information processing methods, a session processing method, an apparatus, a device, and a medium. An information processing method comprises: when a user uses a communication client to browse information, displaying a multi-group information flow page, the multi-group information flow page comprising a group identifier area and an information flow area, the group identifier area displaying at least two first group identifiers, and the information flow area displaying an information flow corresponding to a selected first group identifier among the at least two first group identifiers; and in response to a first preset operation triggered by a user, displaying a single-group information flow page, a corresponding group identifier and a corresponding information flow being displayed in the single-group information flow page. Namely, when a user triggers the first preset operation on the multi-group information flow page, the multi-group information flow page is switched to the single-group information flow page.

This application is a U.S. National Stage under 35 U.S.C. § 371 of International Application No. PCT/CN2023/096191, as filed on May 25, 2023, which claims priority to two China Patent Applications, which comprise China Patent Application No. CN202210603057.5 filed to CNIPA on May 30, 2022, the invention title of which is “INFORMATION PROCESSING METHOD AND APPARATUS, DEVICE AND MEDIUM”, and China Patent Application No. CN202210600706.6 filed to CNIPA on May 30, 2022, the invention title of which is “SESSION PROCESSING METHOD AND APPARATUS, DEVICE AND MEDIUM”, and each of these applications are incorporated by reference in the present application in its entirety.

### TECHNICAL FIELD

The present disclosure belongs to the field of computer technology, in particular to an information processing method and apparatus, a device and a medium, and a session processing method and apparatus, a device and a medium.

### BACKGROUND

With the continuous development of Internet technology, the user may choose more and more messaging clients to realize collaborative work or social interaction, for example, the user may communicate information through instant messaging clients or mailboxes. However, some messaging clients only display the obtained information alone when the information is displayed; when the user needs to view the information of a certain type, it takes time to look it up, which affects the use experience of the user. For example, the pages of the instant messaging client display respective sessions or messages alone, and when the user views a message in a certain session, it takes time to look it up.

### SUMMARY

In order to solve the above-described technical problem or at least partially solve the above-described technical problem, the embodiment of the present disclosure provides an information processing method, a session processing method, an apparatus, a device and a medium, so as to realize grouped display of the information of the messaging client, facilitate grouped browse of the information by the user, and improve the use experience of the user.

According to a first aspect of the present disclosure, an information processing method is provided, the method comprising:
displaying a multiple grouping information flow page; the multiple grouping information flow page comprises a grouping identifier area and an information flow area, wherein the grouping identifier area displays at least two first grouping identifiers, and the information flow area displays an information flow corresponding to a selected first grouping identifier among the at least two first grouping identifiers; and
displaying a single grouping information flow page in response to a first preset operation triggered by the user; the single grouping information flow page displays a corresponding grouping identifier and a corresponding information flow.

According to a second aspect of the present disclosure, an information processing method is provided, the method comprising:
displaying a single grouping information flow page; the single grouping information flow page displays a corresponding grouping identifier and a corresponding information flow;
displaying a multiple grouping information flow page in response to a second preset operation triggered by the user; the multiple grouping information flow page comprises a grouping identifier area and an information flow area, wherein the grouping identifier area displays at least two first grouping identifiers, and the information flow area displays an information flow corresponding to a selected first grouping identifier among the at least two first grouping identifiers.

According to a third aspect of the present disclosure, an information processing method is provided, the method comprising:
receiving a grouping identifier selection operation by the user; wherein different grouping identifiers correspond to different information flow filtering conditions;
displaying a multiple grouping information flow page when a grouping identifier selected by the user is a first grouping identifier; the multiple grouping information flow page comprises a grouping identifier area and an information flow area, wherein the grouping identifier area displays at least two first grouping identifiers, and the information flow area displays an information flow corresponding to a selected first grouping identifier among the at least two first grouping identifiers;
displaying a single grouping information flow page when a grouping identifier selected by the user is not a first grouping identifier; the single grouping information flow page displays a corresponding grouping identifier and an information flow corresponding to the grouping identifier.

According to a fourth aspect of the present disclosure, an information processing apparatus is provided, the apparatus comprising:
a first display unit for displaying a multiple grouping information flow page; the multiple grouping information flow page comprises a grouping identifier area and an information flow area, wherein the grouping identifier area displays at least two first grouping identifiers, and the information flow area displays an information flow corresponding to a selected first grouping identifier among the at least two first grouping identifiers; and
a second display unit configured to display a single grouping information flow page in response to a first preset operation triggered by the user; the single grouping information flow page displays a corresponding grouping identifier and a corresponding information flow.

According to a fifth aspect of the present disclosure, an information processing apparatus is provided, the apparatus comprising:
a first display unit for displaying a single grouping information flow page; the single grouping information flow page displays a corresponding grouping identifier and a corresponding information flow;
a second display unit configured to display a multiple grouping information flow page in response to a second preset operation triggered by the user; the multiple grouping information flow page comprises a grouping identifier area and an information flow area, wherein the grouping identifier area displays at least two first grouping identifiers, and the information flow area displays an information flow corresponding to a selected first grouping identifier among the at least two first grouping identifiers.

According to a sixth aspect of the present disclosure, an information processing apparatus is provided, the apparatus comprising:
a receiving unit configured to receive a grouping identifier selection operation by the user; wherein different grouping identifiers correspond to different information flow filtering conditions;
a first display unit configured to display a multiple grouping information flow page when a grouping identifier selected by the user is a first grouping identifier; the multiple grouping information flow page comprises a grouping identifier area and an information flow area, wherein the grouping identifier area displays at least two first grouping identifiers, and the information flow area displays an information flow corresponding to a selected first grouping identifier among the at least two first grouping identifiers; and
a second display unit configured to display a single grouping information flow page when a grouping identifier selected by the user is not a first grouping identifier; the single grouping information flow page displays a corresponding grouping identifier and an information flow corresponding to the grouping identifier.

According to a seventh aspect of the present disclosure, an electronic device is provided, the device comprising: a processor and a memory; the memory is configured to store instructions or a computer program; the processor is configured to execute the instructions or computer program in the memory, so as to cause the electronic device to perform the method according to the first aspect, the second aspect, or the third aspect.

According to an eighth aspect of the present disclosure, a computer-readable storage medium is provided, wherein the computer-readable storage medium has instructions stored thereon that, when run on a device, cause the device to perform the method according to the first aspect, the second aspect, or the third aspect.

According to a ninth aspect of the present disclosure, a computer program product is provided, the computer program product comprising a computer program or instructions that, when executed by a processor, implement the method according to the first aspect, the second aspect, or the third aspect.

In the embodiment of the present disclosure, when the user browses the information by using a messaging client, the multiple grouping information flow page is displayed, wherein the multiple grouping information flow page comprises a grouping identifier area and an information flow area. Wherein, the grouping identifier area displays at least two first grouping identifiers, and the information flow area displays an information flow corresponding to a selected first grouping identifier among the at least two first grouping identifiers. The user may switch between different first grouping identifiers by a multiple grouping information flow page to view an information flow corresponding to different first grouping identifiers. In response to a first preset operation triggered by the user, a single grouping information flow page is displayed, wherein the single grouping information flow page displays a corresponding grouping identifier and a corresponding information flow. That is, when the user triggers a first preset operation on a multiple grouping information flow page, it is switched from a multiple grouping information flow page to a single grouping information flow page, so that the user may independently view an information flow corresponding to a certain grouping identifier through the single grouping information flow page. It may be seen that, by way of the technical solution provided by the present disclosure, the user may view an information flow corresponding to different groupings through the multiple grouping information flow page or the single grouping information flow page, which facilitates the user to look up required information quickly and improve the use experience of the user.

According to a tenth aspect of the present disclosure, a session processing method is provided, the method comprising:
displaying a grouping information window in response to a first trigger operation in a first page of a messaging client by the user; the grouping information window is used to filter an information flow, and the information flow filtered through the grouping information window comprises one or two of a session or a message; and
hiding the grouping information window in response to a second trigger operation by the user.

In the embodiment of the present disclosure, the hiding the grouping information window in response to a second trigger operation by the user comprises:
hiding the grouping information window and displaying the first page in response to triggering an operation to hide the grouping information window by the user.

In the embodiment of the present disclosure, the grouping information window comprises at least two grouping identifiers, wherein the at least two grouping identifiers correspond to different filtering conditions respectively;
the hiding the grouping information window in response to a second trigger operation by the user comprises:
hiding the grouping information window in response to a trigger operation on one of the at least two grouping identifiers by the user, and displaying an information flow page corresponding to a triggered grouping identifier, wherein the information flow page displays an information flow filtered based on a corresponding filtering condition.

In the embodiment of the present disclosure, the first page comprises an information flow page corresponding to a grouping identifier.

In the embodiment of the present disclosure, the displaying a grouping information window in response to a first trigger operation in a first page of a messaging client by the user comprises:
pulling a grouping information window out from a left edge or a right edge of the first page in response to a first operation triggered by the user on a first page of a messaging client.

In the embodiment of the present disclosure, the displaying a grouping information window in response to a first trigger operation in a first page of a messaging client by the user comprises:
displaying a grouping information window in response to a side slide operation triggered by the user on a first page of a messaging client; or,
displaying a grouping information window in response to a trigger operation on a menu control in a first page of a messaging client by the user, wherein the menu control is used to awaken a grouping information window.

In the embodiment of the present disclosure, the triggered grouping identifier is a first grouping identifier;
the information flow page is a multiple grouping information flow page, and the multiple grouping information flow page comprises a grouping identifier area and an information flow area, wherein the grouping identifier area displays at least two first grouping identifiers, and the information flow area displays an information flow corresponding to a selected first grouping identifier among the at least two first grouping identifiers;
wherein the first grouping identifier refers to a grouping identifier displayed on a multiple grouping information flow page.

In the embodiment of the present disclosure, the method further comprises:
displaying a multiple grouping information flow page by default when the user enters the messaging client;
wherein the multiple grouping information flow page comprises a grouping identifier area and an information flow area, wherein the grouping identifier area displays at least two first grouping identifiers, and the information flow area displays an information flow corresponding to a selected first grouping identifier among the at least two first grouping identifiers; the first page comprises the multiple grouping information flow page.

In the embodiment of the present disclosure, the information flow page is a single grouping information flow page, and the single grouping information flow page displays a corresponding grouping identifier and an information flow corresponding to the grouping identifier.

In the embodiment of the present disclosure, the method further comprises:
displaying a multiple grouping information flow page in response to a closing operation triggered by the user on the single grouping information flow page.

In the embodiment of the present disclosure, a grouping identifier in the single grouping information flow page is different from a first grouping identifier in the multiple grouping information flow page.

In the embodiment of the present disclosure, the grouping information window further comprises an editing control configured to edit grouping information in the grouping information window;
the edit grouping information in the grouping information window comprises one or more of the following:
adding a grouping identifier;
deleting a grouping identifier;
modifying a grouping identifier; or
sorting a current grouping identifier.

In the embodiment of the present disclosure, the at least two grouping identifiers comprise a second grouping identifier with a sub-group identifier, and the grouping information window displays a second grouping identifier and its sub-group identifiers in a secondary structure.

In the embodiment of the present disclosure, the method further comprises:
displaying the second grouping identifier and sub-grouping identifiers corresponding to the one or more sessions with unclosed message notifications in a highlighted manner, and displaying a number of unread messages in the grouping information window when there are unread messages in one or more sessions with unclosed message notifications corresponding to the second grouping identifier; and
displaying the second grouping identifier and sub-group identifiers corresponding to the one or more sessions with closed message notifications in a highlighted manner, but not displaying a number of unread messages in a message grouping window when there are unread messages in one or more sessions with closed message notifications corresponding to the second grouping identifier.

In the embodiment of the present disclosure, the method further comprises:
displaying the grouping identifier in a highlighted manner and/or displaying a number of unread messages in the grouping information window if there are unread messages in a session corresponding to a grouping identifier.

In the embodiment of the present disclosure, in response to the user who is a multiple organization user, the grouping information window further comprises a plurality of organization information corresponding to the user; and the organization to which the user belongs may be switched by triggering the plurality of organization information.

In the embodiment of the present disclosure, the grouping information window further comprises an adding control for adding new organization information corresponding to the user.

According to an eleventh aspect of the present disclosure, a session processing apparatus is provided, wherein the apparatus comprises:
a first display unit for displaying a grouping information window in response to a first trigger operation in a first page of a messaging client by the user; the grouping information window is used to filter an information flow, and the information flow filtered through the grouping information window comprises one or two of a session or a message; and
a hiding unit configured to hide the grouping information window in response to a second trigger operation by the user.

According to a twelfth aspect of the present disclosure, an electronic device is provided, the device comprising: a processor and a memory; the memory is configured to store instructions or a computer program; the processor is configured to execute the instructions or computer program in the memory, so as to cause the electronic device to perform the method according to the tenth aspect.

According to a thirteenth aspect of the present disclosure, a computer-readable storage medium is provided, wherein the computer-readable storage medium has instructions stored thereon that, when run on a device, cause the device to perform the method according to the tenth aspect.

According to a fourteenth aspect of the present disclosure, a computer program product is provided, the computer program product comprising a computer program or instructions that, when executed by a processor, implement the method according to the tenth aspect.

In the embodiment of the present disclosure, when the user triggers a first trigger operation in the first page of the messaging client, the grouping information window will be displayed. Wherein, the grouping information window is configured to filter an information flow, and the information flow filtered through the grouping information window comprises one or two of a session or a message. In response to a second trigger operation by the user, the grouping information window is hidden. That is, the present disclosure provides the grouping information window with the function of filtering an information flow, so that the user may filter an information flow through the grouping information window, so as to obtain a session or message requested by the user and improve the speed of looking up a session or a message by the user. Moreover, when the user does not need a grouping information window, the grouping information window may be hidden by the second trigger operation, which improves the convenience of operation of the grouping information window and improves the use experience of the user.

### BRIEF DESCRIPTION OF THE DRAWINGS

The accompanying drawings which are used to provide a further understanding of the present invention and constitute a part of the specification, are intended to explain the present invention together with the embodiments of the present invention, and do not constitute a limitation on the present invention. In the accompanying drawings:

FIG. 1 is a flowchart of an information processing method provided by an embodiment of the present disclosure;

FIG. 2a is a schematic view of a multiple grouping information flow page provided by an embodiment of the present disclosure;

FIG. 2b is a schematic view of a single grouping information flow page provided by an embodiment of the present disclosure;

FIG. 3a is a schematic view of a grouping information window provided by an embodiment of the present disclosure;

FIG. 3b is a schematic view of another grouping information window provided by an embodiment of the present disclosure;

FIG. 4 is a flowchart of another information processing method provided by an embodiment of the present disclosure;

FIG. 5 is a flowchart of a further information processing method provided by an embodiment of the present disclosure;

FIG. 6 is a structural view of an information processing apparatus provided by an embodiment of the present disclosure;

FIG. 7 is a structural view of another information processing apparatus provided by an embodiment of the present disclosure;

FIG. 8 is a structural view of a further information processing apparatus provided by an embodiment of the present disclosure;

FIG. 9 is a flowchart of a session processing method provided by an embodiment of the present disclosure;

FIG. 10a is a schematic view of a scenario where a grouping information window is awaken provided by an embodiment of the present disclosure;

FIG. 10b is a schematic view of a first page provided by an embodiment of the present disclosure;

FIG. 10c is a schematic view of a grouping information window provided by an embodiment of the present disclosure;

FIG. 10d is a schematic view of an edit grouping page provided by an embodiment of the present disclosure;

FIG. 11a is a schematic view of another grouping information window provided by an embodiment of the present disclosure;

FIG. 11b is a schematic view of a further grouping information window provided by an embodiment of the present disclosure;

FIG. 12a is a schematic view of a multiple grouping information flow page provided by an embodiment of the present disclosure;

FIG. 12b is a schematic view of a single grouping information flow page provided by an embodiment of the present disclosure;

FIG. 12c is a schematic view of another grouping information window provided by an embodiment of the present disclosure;

FIG. 12d is a schematic view of an information flow page corresponding to a second grouping identifier provided by an embodiment of the present disclosure;

FIG. 12e is a schematic view of an information flow page corresponding to a sub-grouping identifier provided by an embodiment of the present disclosure;

FIG. 13 is a schematic view of a session processing apparatus provided by an embodiment of the present disclosure;

FIG. 14 is a schematic structural view of an electronic device provided by an embodiment of the present disclosure.

### DETAILED DESCRIPTION

In order to allow those skilled in the art to better understand the solution of the present disclosure, the technical solution in the embodiments of the present disclosure will be explicitly and completely described below in conjunction with the accompanying drawings in the embodiments of the present disclosure; apparently, the described embodiments are some of the embodiments of the present disclosure, rather than all the embodiments. On the basis of the embodiments of the present disclosure, all the other embodiments obtained by those skilled in the art on the premise that no inventive effort is involved shall fall into the protection scope of the present disclosure.

In order to facilitate the user to look up required information at the messaging client quickly, the present disclosure provides an information processing method, which groups the information in the messaging client in advance and displays the information flow corresponding to each group through different information flow pages.

The messaging client here may be a client of any application with a communication function, comprising an APP client and a webpage client. The application with a communication function may be any application that enables communication between two or more people, for example, an application with an instant messaging function and an application with a mail function, which is not limited here. The application with an instant messaging application function may be an independent instant messaging application or an application in suite software. Similarly, the application with a mail function may be an independent mail application or an application in suite software. The suite software integrates a plurality of applications; taking Office suite software as an example, applications such as instant messaging, email, audio-video conference and cloud document are usually integrated. The present solution is described herein mainly by taking the instant messaging client as an example, but this cannot serve as limiting the present solution.

When the messaging client is an instant messaging client, the information flow may comprise a session and/or a message, that is, one or both of a session and a message. When the messaging client is a mailbox client, the information flow may comprise mail and/or mail content. Specifically, when the user browses the information through the messaging client, the multiple grouping information flow page is displayed, wherein the multiple grouping information flow page comprises a grouping identifier area and an information flow area. Wherein, the grouping identifier area displays at least two first grouping identifiers, and the information flow area displays an information flow corresponding to a selected first grouping identifier among the at least two first grouping identifiers. When the user triggers the first preset operation, it is switched from the multiple grouping information flow page to the single grouping information flow page. The user may view a grouping identifier and an information flow corresponding to the grouping identifier through the single grouping information flow page, so as to allow that the user may view information flows corresponding to different grouping identifiers according to own needs, which facilitates the user to look up required information quickly and improve the use experience of the user.

Wherein, the session comprises a private chat session and a group chat session; the message may be a message in a session, a message pushed by various robot assistants, or a notification message related to other applications in the scenario where the instant messaging application is connected with other applications. For example, the message is a notification message of @me in a document, a notification message of being invited to join a certain schedule or the like.

In order to facilitate the understanding of the technical solution provided by the embodiment of the present disclosure, description will be made below in conjunction with the accompanying drawings.

Referring to FIG. 1, which is a flowchart of an information processing method provided by an embodiment of the present disclosure, the method is performed by a messaging client which may be installed on an electronic device, wherein the electronic device may comprise devices with a communication function such as a mobile phone, a tablet computer, a notebook computer, an on-vehicle terminal, a wearable electronic device, an All-In-One machine and a smart home device, and may also be a virtual machine or a device simulated by a simulator. As shown in FIG. 1, the method may comprise:

In S101, the multiple grouping information flow page is displayed.

In this embodiment, when a preset condition is met, the multiple grouping information flow page is displayed on the messaging client, wherein the multiple grouping information flow page comprises a grouping identifier area and an information flow area. Wherein, the grouping identifier area displays at least two first grouping identifiers, and the information flow area displays an information flow corresponding to a selected first grouping identifier among the at least two first grouping identifiers. Wherein, when the messaging client is an instant messaging client, the information flow may comprise at least one of a session and a message.

Wherein, different first grouping identifiers correspond to different filtering conditions. For example, when the messaging client is an instant messaging client, the filtering conditions may comprise session filtering conditions and message filtering conditions. In the session filtering conditions, filtering is performed at the granularity of a session, and in the message filtering conditions, filtering is performed at the granularity of a message. For example, the session filtering conditions may comprise filtering group chat sessions, filtering private chat sessions and the like, and the groupings indicated by the grouping identifier may comprise group chat session grouping and private chat session grouping; the message filtering conditions may comprise filtering unread messages, filtering reminded (@) messages, and the groupings indicated by the grouping identifier may comprise unread message grouping and reminded message grouping. Wherein, the first grouping identifier comprised in the grouping identifier area may comprise a message grouping identifier and an unread grouping identifier. Wherein, in the multiple grouping information flow page, the number of unread messages in a corresponding session is displayed correspondingly according to each first grouping identifier. The number of unread messages may be the number of unread messages in the sessions with unclosed message notifications corresponding to the first grouping identifier.

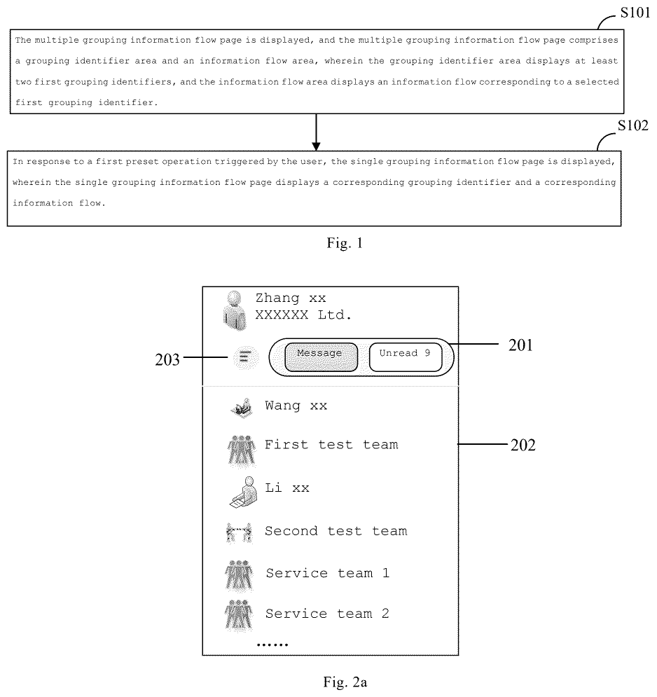

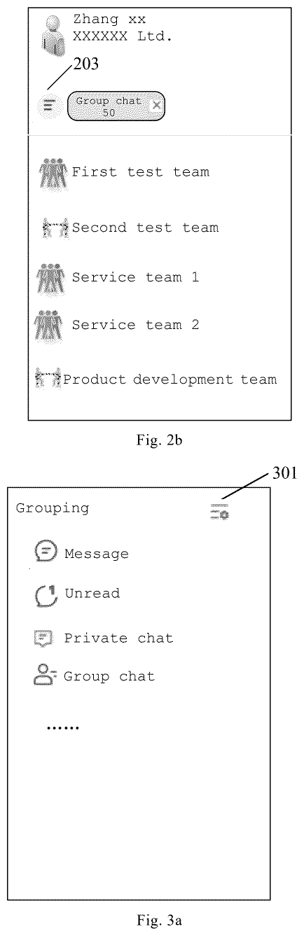

For example, in a schematic view of a multiple grouping information flow page shown in FIG. 2a, the multiple grouping information flow page comprises a grouping identifier area 201 and an information flow area 202. The grouping identifier area 201 displays a first grouping identifier-message and unread grouping identifier, and the information flow area 202 displays an information flow corresponding to a selected “message” grouping. In the application scenario shown in FIG. 2a, the user may switch between different first grouping identifiers; when the user triggers an “unread” grouping, the information flow area 202 will display the information flow corresponding to the “unread” grouping. Wherein, the grouping identifier area may also display the number of unread messages corresponding to the “unread” grouping. Wherein, the user may click and slide to switch between different first grouping identifiers in the grouping identifier area. Here, the first grouping identifier is the grouping identifier in the multiple grouping information flow page.

When the messaging client is a mailbox client, the filtering conditions may comprise mail filtering conditions and mail content filtering conditions, wherein in the mail filtering conditions, filtering is performed at the granularity of a mail, and in the mail content filtering conditions, filtering is performed at the granularity of a mail content. For example, the first grouping identifier displayed in the grouping identifier area comprises a group mail identifier, a single mail identifier, an unread mail identifier, and the like.

Wherein, the preset condition refers to the condition of triggering the messaging client to display the multiple grouping information flow page, and the preset condition may be set according to actual application conditions. Specifically, in response to that the user enters the messaging client, the multiple grouping information flow page is displayed by default. Alternatively, in response to that the user uses a messaging client for the first time and the number of the sessions with unread messages in the messaging client reaches a preset number threshold, the multiple grouping information flow page is displayed. For example, the preset number threshold is 20, and when there are 20 sessions in the messaging client, all of which correspond to unread messages, the multiple grouping information flow page is displayed.

In one embodiment of the present disclosure, at least two first grouping identifiers in the multiple grouping information flow page may be uniformly set by the system, so that the first grouping identifiers displayed in the multiple grouping information flow page are all the same for all the users. Alternatively, a first grouping identifier setting operation of the user is received, and at least two first grouping identifiers in the multiple grouping information flow page are determined according to the first grouping identifier setting operation. That is, the user is allowed to perform a setting operation on the first grouping identifier according to own needs, so that the first grouping identifier comprised in the multiple grouping information flow page is the first grouping identifier set by the user in advance, which improves the use experience of the user and increases the diversity of the multiple grouping information flow page.

In S102, in response to a first preset operation triggered by the user, the single grouping information flow page is displayed.

When the user triggers the first preset operation, it will be switched from the multiple grouping information flow page to the single grouping information flow page. Wherein, the single grouping information flow page displays a corresponding grouping identifier and a corresponding information flow.

Wherein, a grouping identifier corresponding to the single grouping information flow page may be the same as or different from at least two first grouping identifiers in the multiple grouping information flow page. In order to distinguish between the single grouping information flow page and the multiple grouping information flow page, a grouping identifier corresponding to the single grouping information flow page is different from at least two first grouping identifiers in the multiple grouping information flow page. That is, a grouping identifier corresponding to the single grouping information flow page is different from the first grouping identifier in the multiple grouping information flow page. For example, if the first grouping identifier in the multiple grouping information flow page is a message grouping identifier or an unread message grouping identifier respectively, a grouping identifier in a single grouping information flow page may be a group chat grouping identifier or a private chat grouping identifier.

Wherein, the grouping identifier displayed in the single grouping information flow page corresponds to the filtering conditions, so that the information flow displayed in the single grouping information flow page is also filtered based on corresponding filtering conditions. Wherein, in the single grouping information flow page, the number of unread messages in the sessions in a corresponding information flow may also be displayed correspondingly according to its grouping identifier. Wherein, the number of unread messages may be the number of unread messages in the sessions with unclosed message notifications in an information flow corresponding to the grouping identifier.

For example, in a schematic view of a single grouping information flow page shown in FIG. 2b, the single grouping information flow page corresponding to the group chat grouping is displayed, wherein the single grouping information flow page displays a group chat grouping and an information flow corresponding to the group chat grouping. When the group chat grouping is displayed, it is also possible to display the number of unread messages corresponding to the group chat grouping and a corresponding closing control configured to close the current single grouping information flow page. For example, in FIG. 2b, there are 50 unread messages in the group chat grouping, and the number of unread messages is followed by a closing control indicated by the symbol “x”.

In one embodiment of the present disclosure, the displaying a single grouping information flow page in response to a first preset operation triggered by the user comprises: displaying a grouping information window comprising at least two first grouping identifiers and other grouping identifiers in response to a grouping information flow window awakening operation triggered by the user; and displaying a single grouping information flow page corresponding to the grouping identifier in response to a trigger operation on any grouping identifier among the other grouping identifiers by the user. Wherein, the grouping information window comprises a first grouping identifier in the multiple grouping information flow page and a corresponding grouping identifier in each single grouping information flow page. That is, the user may switch between the multiple grouping information flow page and the single grouping information flow page through the grouping information window, which facilitates the user to view different grouping information flow pages quickly.

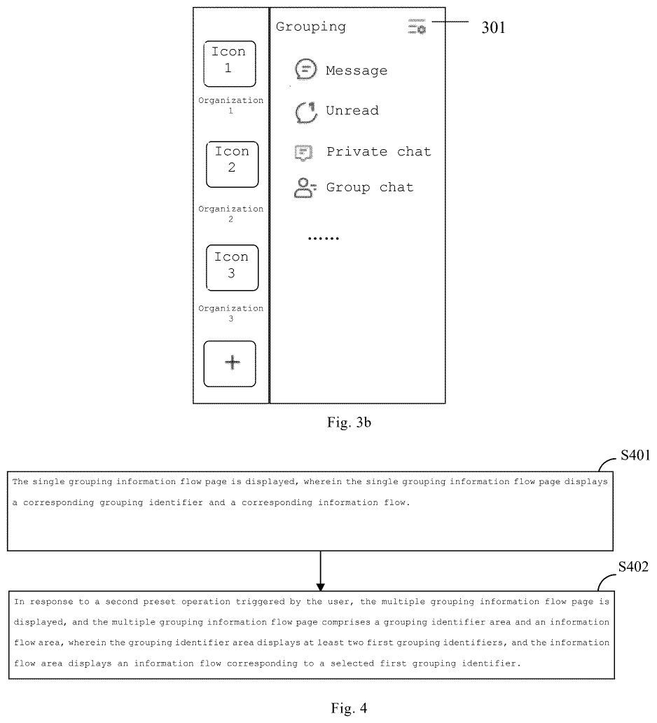

For example, in a schematic view of a grouping information window shown in FIG. 3a, the grouping information window comprises four grouping identifiers-message, unread, group chat and private chat, wherein the message grouping identifier refers to displaying all the sessions in the information flow page corresponding to this grouping. Specifically, when the grouping information window displays each grouping identifier, icons corresponding to each grouping identifier may also be displayed, and as shown in FIG. 3a, a message icon, an unread icon, a group chat icon and a private chat icon are displayed. In the embodiment of the present disclosure, all the grouping identifiers may have corresponding icons; alternatively, some grouping identifiers may have corresponding icons, while some grouping identifiers may not have corresponding icons. When the user triggers the group chat grouping identifier in the grouping information window, the single grouping information flow page corresponding to the group chat grouping identifier is displayed; when the user triggers the private chat grouping identifier in the grouping information window, the single grouping information flow page corresponding to the private chat grouping identifier is displayed.

Wherein, the grouping information window may further comprise an editing control configured to edit the grouping information in the grouping information window. Specifically, the editing the grouping information in the grouping information window may comprise: adding a grouping, deleting a grouping identifier, modifying a grouping identifier and sorting current grouping identifiers. For example, the editing control 301 is shown in FIG. 3a.

Wherein, it is also possible to implement switching between different single grouping information pages through the grouping information window, which facilitates the user to view the information flows in different single grouping information pages. The grouping information window also comprises a plurality of organization information corresponding to the user; the organizations to which the user belongs may be switched by triggering a plurality of organization information. For example, in another grouping information window shown in FIG. 3b, the left area of the grouping information window is an account area, which comprises organization 1, organization 2 and organization 3, and an icon corresponding to each organization; the grouping information area comprises message, unread, group chat and private chat grouping identifiers. Wherein, an icon corresponding to each organization may be triggered, and in response to a trigger operation on a certain icon by the user, it is switched to an organization corresponding to the icon.

In one embodiment of the present disclosure, the displaying a grouping information window in response to a grouping information window awakening operation triggered by the user comprises: displaying a grouping information window in response to a side slide operation on the multiple grouping information flow page triggered by the user; or displaying a grouping information window in response to a trigger operation on a menu control in the multiple grouping information flow page by the user.

That is, when the user triggers a side slide operation in the multiple grouping information flow page or triggers an operation on a menu control in the multiple grouping information flow page, the grouping information window is awakened. Wherein, when the grouping information window is displayed in the form of a sidebar, in response to a grouping information window awakening operation triggered by the user, it is convenient for the grouping information window to pop up in the form of a sidebar from a left edge or a right edge of the multiple grouping information flow page. Wherein, the pop-up grouping information window elbows part of the information in the multiple grouping information flow page out of the display interface. For example, as shown in FIG. 2a, the multiple grouping information flow page may further comprise a menu control 203, which functions to awake the grouping information window; when the user triggers a menu control in the multiple grouping information flow page, the grouping information window as shown in FIG. 3a is awakened. In addition, as shown in FIG. 2b, the menu control 203 is also comprised in the single grouping information flow page; when the user triggers a menu control in the single grouping information flow page, the grouping information window as shown in FIG. 3a is also awakened.

In one embodiment of the present disclosure, it is switched from the single grouping information flow page to a multiple grouping information flow page in response to a second preset operation triggered by the user. Wherein, the second preset operation is configured to trigger the display of the multiple grouping information flow page, and the specific embodied forms of the second preset operation are as follows:

In one embodied form, the multiple grouping information flow page is displayed in response to a closing operation triggered by the user on the single grouping information flow page. Specifically, the single grouping information flow page displays a first control which displays a grouping identifier and a closing identifier corresponding to the single grouping information flow page, and the closing operation triggered by the user on the single grouping information flow page comprises triggering the closing identifier in the first control by the user. For example, the first control in FIG. 2b comprises a group chat grouping identifier and a closing control (a closing identifier), and if the user clicks the closing control, the single grouping information flow page will be closed. For example, in FIG. 2b, when the user clicks a closing control indicated by the symbol “x”, the single grouping information flow page shown in FIG. 2b is closed, and the multiple grouping information flow page shown in FIG. 2a is displayed.

In another embodied form, the grouping information window is displayed in response to the third preset operation triggered by the user. Wherein the grouping information window displays a plurality of grouping identifiers comprising at least two first grouping identifiers; the multiple grouping information flow page is displayed in response to a trigger operation on one of the at least two first grouping identifiers in the grouping information window by the user.

Wherein, the third preset operation refers to an operation by which the grouping information window may be is awakened. For example, the third preset operation is a side slide operation triggered in the single grouping information flow page, and the grouping information window is displayed in response to a side slide operation triggered by the user on the single grouping information flow page; alternatively, the third preset operation is a trigger operation on a menu control in the single grouping information flow page, and the grouping information window is displayed in response to a trigger operation on a menu control in the single grouping information flow page by the user. Wherein, the single grouping information flow page may comprise a menu control configured to awake the grouping information window.

It may be seen that, when the user browses the information by using the messaging client, the multiple grouping information flow page is displayed, wherein the multiple grouping information flow page comprises a grouping identifier area and an information flow area. Wherein, the grouping identifier area displays at least two first grouping identifiers, and the information flow area displays an information flow corresponding to a selected first grouping identifier among the at least two first grouping identifiers. The user may switch between different first grouping identifiers through the multiple grouping information flow page to view information flows corresponding to different first grouping identifiers. In response to the first preset operation triggered by the user, the single grouping information flow page is displayed, wherein the single grouping information flow page displays a corresponding grouping identifier and a corresponding information flow. That is, when the user triggers the first preset operation on the multiple grouping information flow page, it is switched from the multiple grouping information flow page to the single grouping information flow page, so that the user may independently view an information flow corresponding to a certain grouping identifier through the single grouping information flow page. It may be seen that, by way of the technical solution provided by the present disclosure, the user may view information flows corresponding to different groupings through the multiple grouping information flow page or the single grouping information flow page, which facilitates the user to look up required information quickly and improve the use experience of the user.

Referring to FIG. 4, which is another information processing method provided by an embodiment of the present disclosure, the method is performed by a messaging client which may be installed on an electronic device, wherein the electronic device may comprise devices with a communication function such as a mobile phone, a tablet computer, a notebook computer, an on-vehicle terminal, a wearable electronic device, an All-In-One machine and a smart home device, and may also be a virtual machine or a device simulated by a simulator. As shown in FIG. 4, the method may comprise:

In S401, the single grouping information flow page is displayed.

Wherein, the single grouping information flow page displays a corresponding grouping identifier and a corresponding information flow. For the operation of awakening the single grouping information flow page, reference may be made to the related descriptions of S102 described above.

In S402, in response to a second preset operation triggered by the user, the multiple grouping information flow page is displayed.

In this embodiment, when the user triggers the second preset operation, the user switches from the single grouping information flow page to the multiple grouping information flow page. The multiple grouping information flow page comprises a grouping identifier area and an information flow area, wherein the grouping identifier area displays at least two first grouping identifiers, and the information flow area displays an information flow corresponding to a selected first grouping identifier among the at least two first grouping identifiers.

Wherein, a grouping identifier corresponding to the single grouping information flow page may be the same as or different from at least two first grouping identifiers in the multiple grouping information flow page. For the specific embodiments of the second preset operation, reference may be made to the related descriptions in S101 and S102 described above.

In one embodiment of the present disclosure, the displaying a multiple grouping information flow page in response to a second preset operation triggered by the user comprises: displaying a multiple grouping information flow page in response to a closing operation triggered by the user on the single grouping information flow page. Specifically, the single grouping information flow page displays a first control which displays a grouping identifier and a closing identifier corresponding to the single grouping information flow page, and the closing operation comprises a trigger operation on the closing identifier in the first control by the user.

In one embodiment of the present disclosure, the displaying a multiple grouping information flow page in response to a second preset operation triggered by the user comprises: displaying a grouping information window in response to a grouping information window awakening operation triggered by the user, wherein the grouping information window displays a plurality of grouping identifiers comprising at least two first grouping identifiers; and displaying a multiple grouping information flow page in response to a trigger operation on one of the at least two first grouping identifiers in the grouping information window by the user.

Wherein, the displaying a grouping information window in response to a grouping information window awakening operation triggered by the user comprises: displaying a grouping information window in response to a side slide operation triggered by the user on the single grouping information flow page; or displaying a grouping information window in response to a trigger operation on a menu control in the single grouping information flow page by the user.

It may be seen that, when the user browses the information by using the messaging client, the single grouping information flow page is displayed, wherein the single grouping information flow page displays a corresponding grouping identifier and a corresponding information flow. In response to the first preset operation on the multiple grouping information flow page triggered by the user, the multiple grouping information flow page is displayed, wherein the multiple grouping information flow page comprises a grouping identifier area and an information flow area. Wherein, the grouping identifier area displays at least two first grouping identifiers, and the information flow area displays an information flow corresponding to a selected first grouping identifier among the at least two first grouping identifiers. The user may switch between different first grouping identifiers through the multiple grouping information flow page to view information flows corresponding to different first grouping identifiers. That is, when the user triggers the second preset operation, it is switched from the single grouping information flow page to the multiple grouping information flow page, so as to allow that the user may view an information flow corresponding to each first grouping identifier through the multiple grouping information flow page. It may be seen that, by way of the technical solution provided by the present disclosure, the user may view information flows corresponding to different groupings through the multiple grouping information flow page or the single grouping information flow page, which facilitates the user to look up required information quickly and improve the use experience of the user.

Since the multiple grouping information flow page integrates a plurality of groups commonly used by the user, the solution of setting the multiple grouping information flow page to be a default page and switching from the single grouping information flow page to the multiple grouping information flow page quickly is greatly convenient for the user and improves the efficiency of the user.

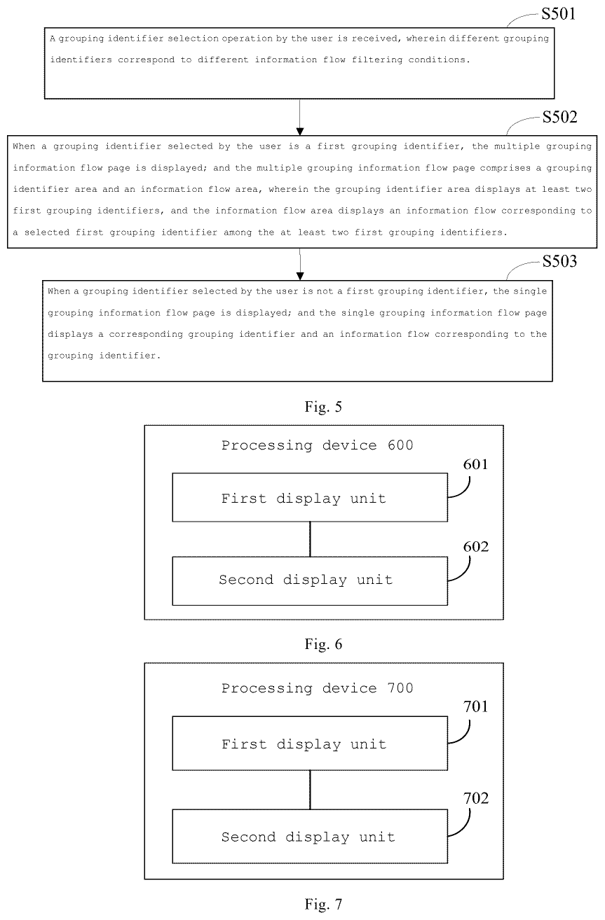

Referring to FIG. 5, which is a flowchart of a further information processing method provided by an embodiment of the present disclosure, as shown in FIG. 5, the method may comprise:

In S501, a grouping identifier selection operation by the user is received, wherein different grouping identifiers correspond to different information flow filtering conditions.

In this embodiment, one or more grouping identifiers may be displayed to the user, and a grouping identifier selection operation by the user is received in response to a trigger operation on a certain grouping identifier by the user.

In one embodiment of the present disclosure, one or more grouping identifiers may be displayed to the user through a grouping information window. Specifically, the user may display the grouping information window by triggering a grouping information window awakening operation. For the operation of awakening the grouping information window, reference may be made to the related descriptions in the embodiment shown in FIG. 1 or 4, which will not be described in detail here in this embodiment.

In S502, when a grouping identifier selected by the user is a first grouping identifier, the multiple grouping information flow page is displayed.

Wherein, the multiple grouping information flow page comprises a grouping identifier area and an information flow area. The grouping identifier area displays at least two first grouping identifiers, and the information flow area displays an information flow corresponding to a selected first grouping identifier among the at least two first grouping identifiers.

For the specific embodiments of the multiple grouping information flow page and the first grouping identifier, reference may be made to the relevant descriptions in the embodiments described in FIG. 1 or 4 described above.

In S503, when a grouping identifier selected by the user is not a first grouping identifier, the single grouping information flow page is displayed.

Wherein, the single grouping information flow page displays a corresponding grouping identifier and an information flow corresponding to the grouping identifier. For the related content of the single grouping information flow page, reference may be made to the related descriptions in the examples in FIG. 1 or 4 described above.

In one example of the present disclosure, it is switched from the multiple grouping information flow page to the single grouping information flow page in response to a current display of the multiple grouping information flow page and a first preset operation triggered by the user. That is, it is possible to implement switching from the multiple grouping information flow page to the single grouping information flow page through the first preset operation, which facilitates switching between different information flow pages.

Wherein, regarding the first preset operation triggered by the user, for the specific implementations of switching from the multiple grouping information flow page to the single grouping information flow page, reference may be made to the related descriptions in FIG. 1 or 4 described above.

In one embodiment of the present disclosure, it is switched from the single grouping information flow page to the multiple grouping information flow page in response to a current display of the single grouping information flow page and the second preset operation triggered by the user. That is, it is possible to implement switching from the single grouping information flow page to the multiple grouping information flow page through the second preset operation, which facilitates switching between different information flow pages.

Wherein, regarding the second preset operation triggered by the user, for the specific implementations of switching from the single grouping information flow page to the multiple grouping information flow page, reference may be made to the related descriptions in the example in FIG. 1 or 4 described above.

Based on the above-described method embodiments, the embodiment of the present disclosure also provides an information processing apparatus, which will be described below in conjunction with the accompanying drawings.

Referring to FIG. 6, which is a structural view of an information processing apparatus provided by an embodiment of the present disclosure, as shown in FIG. 6, the apparatus 600 comprises a first display unit 601 and a second display unit 602.

Wherein, the first display unit 601 is configured to display a multiple grouping information flow page; the multiple grouping information flow page comprises a grouping identifier area and an information flow area, wherein the grouping identifier area displays at least two first grouping identifiers, and the information flow area displays an information flow corresponding to a selected first grouping identifier among the at least two first grouping identifiers.

The second display unit 602 is configured to display a single grouping information flow page in response to a first preset operation triggered by the user; the single grouping information flow page displays a corresponding grouping identifier and a corresponding information flow.

In one embodiment of the present disclosure, a grouping identifier corresponding to the single grouping information flow page is different from the at least two first grouping identifiers in a multiple grouping information flow page.

In one embodiment of the present disclosure, the apparatus further comprises a switching unit.

The switching unit is configured to switch from the single grouping information flow page to a multiple grouping information flow page in response to a second preset operation triggered by the user.

In one embodiment of the present disclosure, the switching unit is specifically configured to display a multiple grouping information flow page in response to a closing operation triggered by the user on the single grouping information flow page; or displaying a grouping information window in response to a third preset operation triggered by the user, wherein the grouping information window displays a plurality of grouping identifiers comprising the at least two first grouping identifiers; and displaying a multiple grouping information flow page in response to a trigger operation on one of the at least two first grouping identifiers in the grouping information window by the user.

In one embodiment of the present disclosure, the single grouping information flow page displays a first control which displays a grouping identifier and a closing identifier corresponding to the single grouping information flow page; the closing operation triggered by the user on the single grouping information flow page comprises: triggering a closing identifier in the first control by the user.

In one embodiment of the present disclosure, the second display unit 602 is specifically configured to display a grouping information window in response to a grouping information window awakening operation triggered by the user, wherein the grouping information window comprises the at least two first grouping identifiers and other grouping identifiers; and display a single grouping information flow page corresponding to the grouping identifier in response to a trigger operation on any of the other grouping identifiers by the user.

In one embodiment of the present disclosure, the second display unit 602 is specifically configured to display a grouping information window in response to a side slide operation triggered by the user in the multiple grouping information flow page; or display a grouping information window in response to a trigger operation on a menu control in the multiple grouping information flow page by the user.

In one embodiment of the present disclosure, the first display unit 601 is further configured to display the multiple grouping information flow page in response to that the user uses a messaging client for the first time and the number of the sessions with unread messages in the messaging client reaches a preset number threshold.

In one embodiment of the present disclosure, the at least two first grouping identifiers comprise: a message grouping identifier and an unread grouping identifier.

In one embodiment of the present disclosure, the apparatus further comprises a third display unit.

The third display unit is configured to display the number of unread messages in a corresponding session correspondingly according to each first grouping identifier in the multiple grouping information flow page; and/or, display the number of unread messages in a corresponding session correspondingly according to the grouping identifier in the single grouping information flow page.

In one embodiment of the present disclosure, at least two first grouping identifiers in the multiple grouping information flow page are uniformly set by the system; alternatively, the apparatus comprises a receiving unit and a determining unit; the receiving unit is configured to receive a first grouping identifier setting operation of the user; and the determining unit is configured to determine the at least two first grouping identifiers in the multiple grouping information flow page according to the first grouping identifier setting operation.

In one embodiment of the present disclosure, one or more of the following are comprised:
the grouping information window comprises an editing control configured to edit the grouping information in the grouping information window;
in the grouping information window, if there are unread messages in a session corresponding to a grouping identifier, the grouping identifier is displayed in a highlighted manner and/or the number of unread messages is displayed;
the grouping information window also comprises a plurality of organization information corresponding to the user;
the organization to which the user belongs may be switched by triggering the plurality of organization information.

It is to be noted that, for the implementations of each unit in this embodiment, reference may be made to the relevant descriptions in the method embodiment shown in FIG. 1 described above.

Referring to FIG. 7, which is another information processing apparatus provided by an embodiment of the present disclosure, the device 700 comprises: a first display unit 701 and a second display unit 702.

The first display unit 701 is configured to display a single grouping information flow page; the single grouping information flow page displays a corresponding grouping identifier and a corresponding information flow.

The second display unit 702 is configured to display a multiple grouping information flow page in response to a second preset operation triggered by the user; the multiple grouping information flow page comprises a grouping identifier area and an information flow area, wherein the grouping identifier area displays at least two first grouping identifiers, and the information flow area displays an information flow corresponding to a selected first grouping identifier among the at least two first grouping identifiers.

In one embodiment of the present disclosure, a grouping identifier corresponding to the single grouping information flow page is different from the at least two first grouping identifiers in a multiple grouping information flow page.

In one embodiment of the present disclosure, the second display unit 702 is specifically configured to display a multiple grouping information flow page in response to a closing operation triggered by the user on the single grouping information flow page; or display a grouping information window in response to a grouping information window awakening operation triggered by the user, wherein the grouping information window displays a plurality of grouping identifiers comprising the at least two first grouping identifiers; and display a multiple grouping information flow page in response to a trigger operation on one of the at least two first grouping identifiers in the grouping information window by the user.

In one embodiment of the present disclosure, the single grouping information flow page displays a first control, which displays a grouping identifier and a closing identifier corresponding to the single grouping information flow page; the closing operation triggered by the user on the single grouping information flow page comprises: triggering a closing identifier in the first control by the user.

In one embodiment of the present disclosure, the second display unit 702 is specifically configured to display a grouping information window in response to a side slide operation triggered by the user on the single grouping information flow page; or display a grouping information window in response to a trigger operation on a menu control in the single grouping information flow page by the user.

It is to be noted that, for the specific implementations of each unit in this embodiment, reference may be made to the relevant descriptions in the method example shown in FIG. 4 described above, which will not be described in detail here in this embodiment.

Referring to FIG. 8, which is a structural view of another information processing apparatus provided by an embodiment of the present disclosure, as shown in FIG. 8, the apparatus 800 comprises a receiving unit 801, a first display unit 802 and a second display unit 803.

The receiving unit 801 is configured to receive a grouping identifier selection operation by the user; wherein, different grouping identifiers correspond to different information flow filtering conditions.

The first display unit 802 is configured to display a multiple grouping information flow page when a grouping identifier selected by the user is a first grouping identifier; the multiple grouping information flow page comprises a grouping identifier area and an information flow area, wherein the grouping identifier area displays at least two first grouping identifiers, and the information flow area displays an information flow corresponding to a selected first grouping identifier among the at least two first grouping identifiers.

The second display unit 803 is configured to display a single grouping information flow page when a grouping identifier selected by the user is not a first grouping identifier; the single grouping information flow page displays a corresponding grouping identifier and an information flow corresponding to the grouping identifier.

In one embodiment of the present disclosure, the apparatus further comprises a switching unit; the switching unit is configured to switch from the multiple grouping information flow page to the single grouping information flow page in response to a current display of the multiple grouping information flow page and a first preset operation triggered by the user.

In one embodiment of the present disclosure, the apparatus further comprises a switching unit; the switching unit is configured to switch from the single grouping information flow page to the multiple grouping information flow page in response to a current display of the single grouping information flow page and a second preset operation triggered by the user.

It is to be noted that, for the specific implementations of each unit in this embodiment, reference may be made to the relevant descriptions in the method embodiment shown in FIG. 5 described above.

On the other hand, in order to improve the user's experience in using the messaging client and facilitate the user to look up a required session or message quickly, the present disclosure provides a session processing method; specifically, a grouping information window may be set in advance, wherein the grouping information window is configured to filter an information flow, and the information flow filtered through the grouping information window comprises one or two of a session or a message. When the user performs a first trigger operation in the first page of the messaging client, a grouping information window is displayed, so that the user may filter a required session and/or message through the grouping information window. When the user does not need a grouping information window, the grouping information window is hidden by the second trigger operation. That is, the user may awake or hide the grouping information window through different trigger operations, so that the user may perform filtering quickly through the grouping information window and improve the use experience of the user when the user needs to filter a session and/or a message.

Wherein, the messaging client may be an independent instant messaging client or an instant messaging client integrated with a suite software. Wherein, the suite software refers to Office software that integrates multiple functions, for example, integrating any multiple functions such as address book, instant messaging tool, audio-video conference, cloud document, schedule, workbench, email, calendar, and tasks.

In order to facilitate the understanding of the technical solution provided by the present disclosure, description will be made below in conjunction with the accompanying drawings.

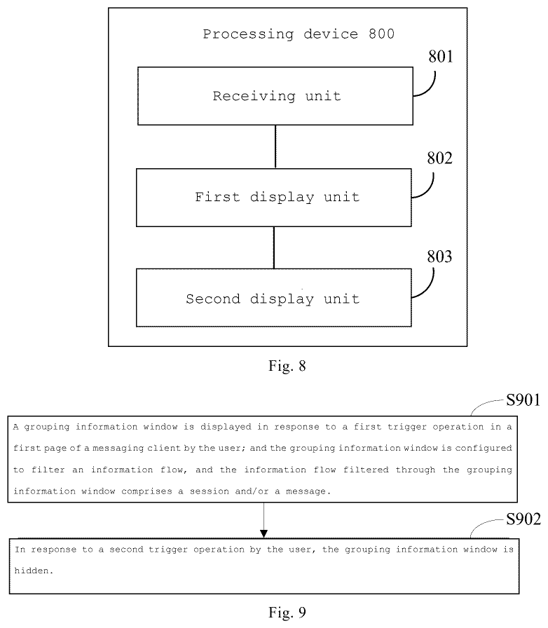

Referring to FIG. 9, which is a flowchart of a session processing method provided by an embodiment of the present disclosure, as shown in FIG. 9, the method is performed by a messaging client, which may be installed on an electronic device, wherein the electronic device may comprise devices with a communication function such as a mobile phone, a tablet computer, a notebook computer, a desktop computer, a TCU, a wearable electronic device, an on-vehicle terminal, a wearable electronic device, an All-In-One machine and a smart home devices, and may also be a virtual machine or a device simulated by a simulator. As shown in FIG. 9, the method may comprise:

In S901, a grouping information window is displayed in response to a first trigger operation in a first page of a messaging client by the user.

In this embodiment, when the operation triggered by the user in the first page of the messaging client is the first trigger operation, the grouping information window will be displayed. Wherein, the grouping information window is configured to filter an information flow, and the information flow filtered through the grouping information window comprises one or two of a session and/or a message. That is, the user may filter required information flow through the grouping information window.

Wherein, the first page may be any page in the messaging client. For example, it may be a home page displayed upon entering the messaging client, or it may be an information flow page corresponding to any grouping identifier. When the operation in the first page by the user is a first trigger operation, a grouping information window is displayed. Wherein, the grouping information window may be displayed in the form of a sidebar.

In one embodiment of the present disclosure, when a grouping information window is displayed in the form of a sidebar, the grouping information window is pulled out from a left edge or a right edge of the first page in response to a first operation triggered by the user in the first page of the messaging client. Wherein, the grouping information window pulled out elbows a part of the information of the first page out of the display interface.

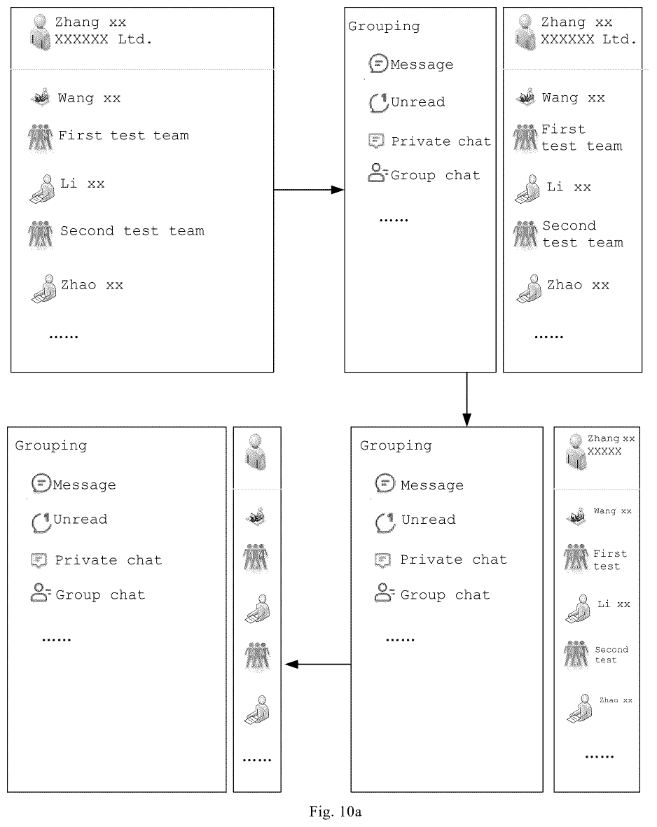

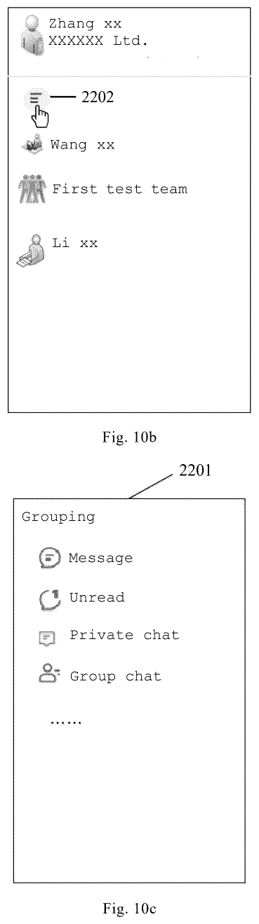

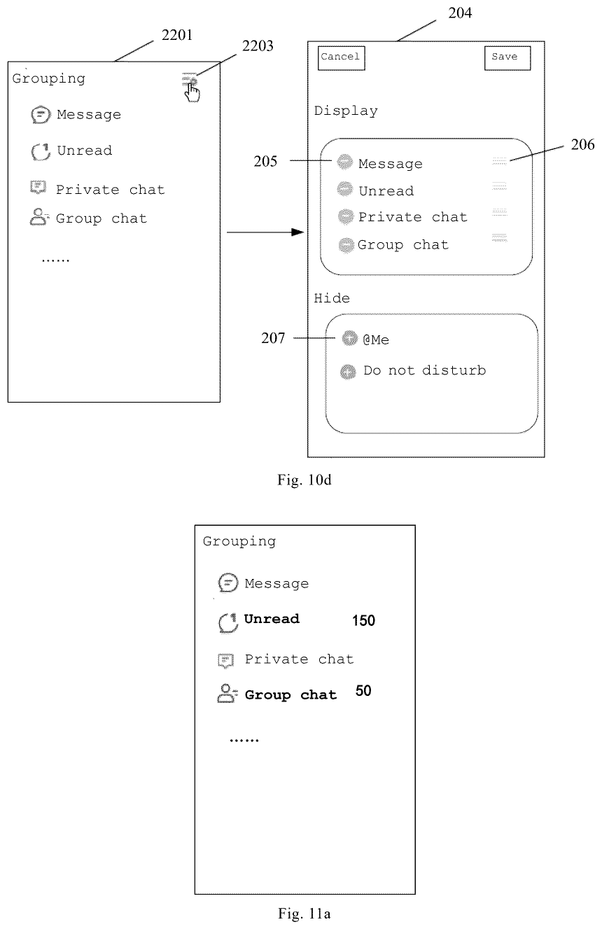

Referring to FIG. 10a, which is a schematic view of a scenario where a grouping information window is awaken provided by an embodiment of the present disclosure. As shown in FIG. 10a, the left side is an exemplary view of the first page, and the first page displays an avatar and name of the user, an organization to which the user belongs, and a session information flow of the user in the messaging client. In response to a first trigger operation in the first page by the user, viewed in the direction indicated by the arrow in FIG. 10a, the grouping information window 2201 is pulled out from the left edge, and elbows the first page to the right, so that a part of the information in the first page is elbowed out of the display page. As the user continues to pull out the grouping information window to the right, the displayed grouping information window becomes larger and larger, the first page becomes smaller and smaller, and more and more information in the first page is elbowed out of the display page.

The first trigger operation may comprise a side slide operation triggered by the user in the first page, and a grouping information window is displayed in response to the side slide operation. Wherein, the side slide operation refers to an operation that the user slides from the left edge to the right of the first page, or an operation that the user slides from the right edge to the left of the first page. Alternatively, the first trigger operation is a trigger operation on a menu control in the first page by the user, and a grouping information window is displayed in response to a trigger operation on a menu control. Wherein, the menu control is used to awake the grouping information window. Refer to FIG. 10b, which is a schematic view of a first page provided by an embodiment of the present disclosure. As shown in FIG. 10b, the first page comprises a menu control 2202, and when the user clicks the menu control 2202, a grouping information window 2201 is awakened.

In S902, in response to a second trigger operation by the user, the grouping information window is hidden.

In the case where a grouping information window is displayed, when the user performs a second trigger operation, the grouping information window will be hidden.

It may be seen that, when the user triggers a first trigger operation in the first page of the messaging client, the grouping information window will be displayed. Wherein, the grouping information window is configured to filter an information flow, and the information flow filtered through the grouping information window comprises one or two of a session or a message. In response to a second trigger operation by the user, the grouping information window is hidden. That is, in the present disclosure, the grouping information window with the function of filtering an information flow is provided so that the user may filter an information flow through the grouping information window, so as to obtain a session or message requested by the user and improve the speed of looking up a session or a message by the user. Moreover, when the user does not need a grouping information window, the grouping information window may be hidden by the second trigger operation, which improves the convenience of operation on the grouping information window and improves the use experience of the user. Especially in a small-screen electronic device such as a mobile phone, after an independent and hidable grouping information window is set, it is possible to expand the information flow display space in the information flow page and improve the information flow display efficiency without displaying the grouping information in the information flow page.

Wherein, the second trigger operation corresponds to different specific operations according to different application scenarios, which will be explained respectively below.

In one embodiment of the present disclosure, the hiding the grouping information window in response to a second trigger operation by the user comprises: hiding the grouping information window in response to triggering an operation to hide the grouping information window by the user, and displaying the first page. In this embodiment, an operation to hide the grouping information window may be set in advance; when the operation triggered by the user is an operation to hide the grouping information window, the grouping information window is hidden and the first page is displayed, which improves the convenience of operation on the grouping information window by the user. Specifically, the operation to hide the grouping information window may comprise one or more of the following: clicking on a blank space in the grouping information window; click a close button set in the grouping information window and the like.

In one embodiment of the present disclosure, the grouping information window comprises at least two grouping identifiers, wherein the at least two grouping identifiers correspond to different filtering conditions respectively; the hiding the grouping information window in response to a second trigger operation by the user comprises: hiding the grouping information window and displaying an information flow page corresponding to a triggered grouping identifier in response to a trigger operation on one of at least two grouping identifiers by the user. Wherein, the information flow page displays an information flow filtered based on a corresponding filtering condition.

In this embodiment, different grouping identifiers may be set in advance, and each grouping identifier corresponds to a filtering condition; based on a corresponding filtering condition, an information flow corresponding to the grouping identifier may be filtered. The information flow comprises one or two of a session and a message, wherein the session here comprises a private chat session and a group chat session, and the message comprises a session message, a notification message of someone @ you in a document, a notification message pushed by robot and the like. When the user performs a first trigger operation in the first page of the messaging client, a grouping information window is displayed, wherein the grouping information window comprises at least two grouping identifiers. In response to a trigger operation on one of at least two grouping identifiers by the user, an information flow page corresponding to a triggered grouping identifier is displayed, and the information flow page displays an information flow corresponding to the grouping identifier, so as to allow that the user may view a required session or message through the information flow page and improve the use experience of the user.

Since different grouping identifiers correspond to different filtering conditions, the information flow displayed in the information flow page is a session or message filtered based on a filtering condition corresponding to the grouping identifier, so as to allow that the user may view a required session or message through the information flow page, which implements positioning a required session or message quickly and improves the use experience of the user.

Wherein, the filtering conditions may comprise filtering a group chat session, filtering a private chat session and the like, and the grouping indicated by the grouping identifier may comprise a group chat session grouping and a private chat session grouping; the filtering conditions may also comprise filtering an unread message, filtering a reminded (@) message and the like, and the grouping indicated by the grouping identifier may comprise an unread message grouping and a reminded message grouping.

For example, in a schematic view of the grouping information window shown in FIG. 10c, the grouping information window 2201 comprises four groupings: message, unread, group chat and private chat. Wherein, the message grouping refers to selecting a session to which all the messages belong. Specifically, when the grouping information window displays each grouping identifier, an icon corresponding to each grouping identifier may also be displayed, as shown in FIG. 10c, and a message icon, an unread icon, a group chat icon and a private chat icon are displayed. In the embodiment of the present disclosure, all the grouping identifiers may have corresponding icons, or some grouping identifiers may have corresponding icons while some grouping identifiers may not have corresponding icons.

In one embodiment of the present disclosure, the grouping information window may further comprise an editing control configured to edit the grouping information in the grouping information window. Wherein, the editing the grouping information in the grouping information window comprises one or more of the following: adding a grouping identifier, deleting a grouping identifier, modifying a grouping identifier and sorting a current grouping identifier. Specifically, the user may enter the edit grouping page by triggering the editing control. Each grouping identifier that has been created based on different filtering conditions is displayed in this edit grouping page, and the user may add a grouping identifier that has not been displayed in the grouping information window or delete a grouping identifier that has been displayed in the grouping information window according to own needs.

For example, in a schematic view of the edit grouping page shown in FIG. 10d, the grouping information window 2201 comprises an editing control 2203, and by triggering this editing control 2203, an edit grouping page 204 is displayed, wherein the edit grouping page 204 comprises two display areas, which are a display area and a hidden area respectively. Wherein, the display area comprises the grouping identifiers that have been displayed in the grouping information window: message, unread, private chat and group chat, and a deletion control 205 and a sequence adjusting control 206 corresponding to each grouping identifier; the hidden area comprises the grouping identifiers that have not been displayed in the grouping information window: @ me, Do Not Disturb, and the like, and an adding control 207 corresponding to each grouping identifier. Wherein, the Do Not Disturb grouping is used to filter a session with a closed message notification. By way of the edit grouping page shown in FIG. 10d, the user may delete a grouping identifier in a display area from the grouping message window through the deletion control 205, adjust a display sequence of the grouping identifier in the display area in the grouping message window through the sequence adjusting control 206, and add a grouping identifier in the hidden area to the grouping message window through the adding control 207.

Wherein, a display sequence and an addition sequence of each grouping identifier in the grouping message window are associated. In general, the display position of the message grouping identifier is a position closest to the top of the grouping message window.

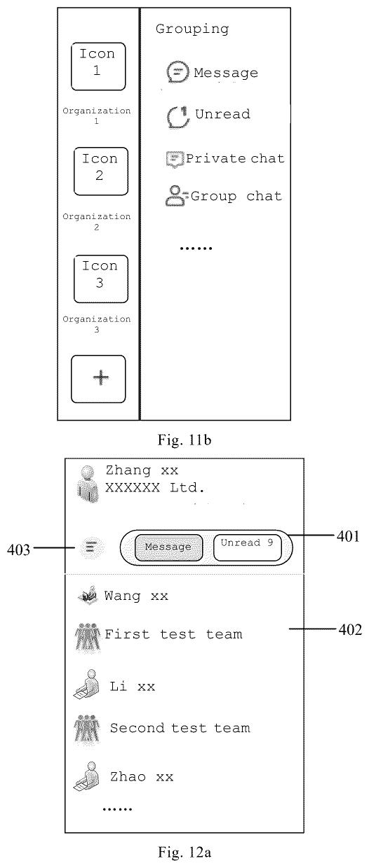

In one embodiment of the present disclosure, in the grouping information window, when there are unread messages in a session corresponding to a certain grouping identifier, the grouping identifier and/or the number of unread messages is/are displayed in a highlighted manner. Wherein, the highlight may be bold display, highlight display and the like, so as to attract the attention of the user and facilitate the user to know which grouping identifier is present with unread messages. For example, in a schematic view of another grouping information window shown in FIG. 11a, when a group chat grouping comprises 50 unread messages, the group chat grouping is displayed in bold, and at the same time, the number of unread messages is displayed correspondingly. When there are unread messages in the group chat grouping, and correspondingly there are also unread messages in the unread grouping, the unread grouping may be displayed in bold, and the number of unread messages (the number of unread messages comprises the sum of the number of unread messages of all the other grouping identifiers) may be displayed.

In one embodiment of the present disclosure, when the user is a multiple organization user, the grouping information window further comprises a plurality of organization information corresponding to the user; the plurality of organization information are triggered to switch the organizations to which the user belongs.

Specifically, the grouping information window may be divided into a grouping information area and an account area. Wherein, the grouping information area comprises at least two grouping identifiers, and the account area comprises a plurality of organization information corresponding to users. For example, FIG. 11b is a schematic view of a further grouping information window; the left area of the grouping information window is the account area, which comprises organization 1, organization 2 and organization 3, and an icon corresponding to each organization; the grouping information area comprises message, unread, group chat and private chat grouping identifiers. Wherein, an icon corresponding to each organization may be triggered, and in response to a trigger operation on a certain icon by the user, it is switched to an organization corresponding to the icon. In addition, the account area may also comprise an adding control, through which new organization information corresponding to the user may be added.

In one embodiment of the present disclosure, the information flow page may comprise a multiple grouping information flow page and a single grouping information flow page. Wherein, the multiple grouping information flow page comprises a grouping identifier area and an information flow area, wherein the grouping identifier area displays at least two first grouping identifiers, and the information flow area displays an information flow corresponding to a selected first grouping identifier among the at least two first grouping identifiers. Wherein, the at least two first grouping identifiers may comprise grouping identifiers commonly used by the user, for example, message and unread grouping identifiers. The single grouping information flow page displays a grouping identifier and an information flow corresponding to the grouping identifier. Wherein, the grouping identifier of the single grouping information flow page may be the same as or different from the first grouping identifier in the multiple grouping information flow page. For example, the grouping information window comprises a message grouping identifier, an unread grouping identifier, a group chat grouping identifier and a private chat grouping identifier, and the first grouping identifier comprises a message grouping identifier and an unread grouping identifier, and thus, the grouping identifier of the single grouping information flow page is a group chat grouping identifier or a private chat grouping identifier.

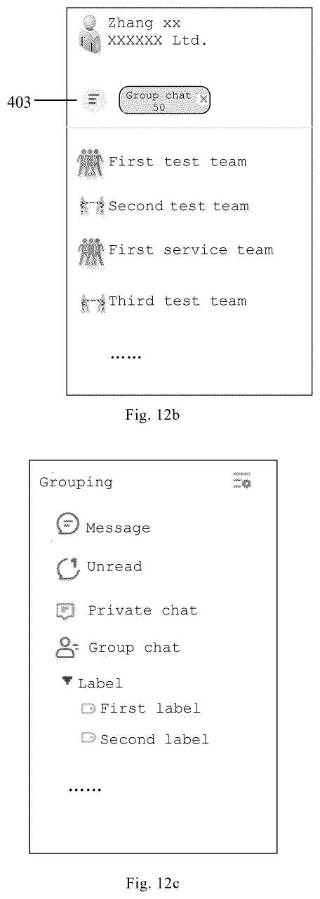

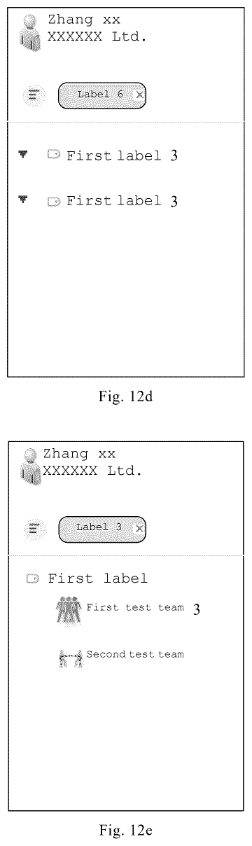

When the grouping identifier triggered by the user is the first grouping identifier, the displayed information flow page is a multiple grouping information flow page, and the multiple grouping information flow page displays a session or a message corresponding to at least two first grouping identifiers and a triggered first grouping identifier. For example, in a schematic view of the multiple grouping information flow page shown in FIG. 12a, the multiple grouping information flow page comprises a grouping identifier area 401 and an information flow area 402. The grouping identifier area 401 displays two first grouping identifiers-message and unread grouping identifiers, and the information flow area 402 displays an information flow corresponding to a selected “message” grouping. In addition, the multiple grouping information flow page may also comprise a menu control 403, which functions to awake the grouping information window 2201. In the application scenario shown in FIG. 12a, the user may switch between different first grouping identifiers; when the user triggers an “unread” grouping, the information flow area 402 will display a session corresponding to the “unread” grouping. Wherein, the grouping identifier area may also display the number of unread messages corresponding to the unread grouping. For example, there are 9 unread messages in the unread grouping in FIG. 12a.

In one embodiment of the present disclosure, when the user enters the messaging client, the interface of the messaging client will display a multiple grouping information flow page by default. That is, the first page comprises a multiple grouping information flow page. Since the multiple grouping information flow page integrates several grouping identifiers commonly used by the user, the multiple grouping information flow page is set to be a default page, which is convenient for the user and improves the efficiency.

When the grouping identifier triggered by the user in the grouping information window is not the first grouping identifier, the displayed information flow page is a single grouping information flow page. For example, in a schematic view of the single grouping information flow page in FIG. 12b, when the grouping identifier triggered by the user in the grouping information window is a group chat grouping, the single grouping information flow page corresponding to the group chat grouping is displayed, wherein the single grouping information flow page displays a group chat grouping and an information flow corresponding to the group chat grouping. When a group chat grouping is displayed, the number of unread messages corresponding to the group chatting grouping and a corresponding closing control may also be displayed; for example, in FIG. 12b, there are 50 unread messages in the group chatting grouping, and the number of unread messages is followed by a closing control indicated by the symbol “x”.

In one embodiment of the present disclosure, the multiple grouping information flow page is displayed in response to a closing operation triggered by the user on the single grouping information flow page. Wherein, the closing operation may comprise clicking a closing control, or a stretch operation triggered on a grouping identifier in the single grouping information flow page; in response to a stretch operation triggered by the user, the single grouping information flow page is closed and the multiple grouping information flow page is pulled out. For example, in FIG. 12b, when the user clicks a closing control indicated by the symbol “x”, the single grouping information flow page shown in FIG. 12b is closed, and the multiple grouping information flow page shown in FIG. 12a is displayed.

Since the multiple grouping information flow page integrates a plurality of groups commonly used by the user, the solution of setting the multiple grouping information flow page to be a default page and switching from the single grouping information flow page to the multiple grouping information flow page quickly is greatly convenient for the user and improves the efficiency of the user.

It may be seen that, when the user triggers a first trigger operation in the first page of the messaging client, a grouping information window will be displayed, wherein the grouping information window comprises at least two grouping identifiers corresponding to different filtering conditions. That is, the messaging client may group sessions or messages based on different filtering conditions. In response to a trigger operation on one of at least two grouping identifiers by the user, an information flow page corresponding to a triggered grouping identifier is displayed, and an information flow filtered based on a corresponding filtering condition is displayed in the information flow page. That is, the user may trigger a certain grouping identifier to view a session or message corresponding to the grouping identifier, so as to improve the speed of looking up a session or message by the user, which facilitates the user to look up a required session or message quickly, and improve the use experience of the user.

In one embodiment of the present disclosure, at least two grouping identifiers comprised in the grouping information window also comprise a second grouping identifier with a sub-grouping identifier, and the grouping information window displays the second grouping identifier and its sub-grouping identifiers in a secondary structure. Wherein, the second grouping identifier may be a label grouping identifier. For example, the grouping information window shown in FIG. 12c comprises a label grouping identifier. Wherein, the label grouping identifier comprises a first label sub-grouping identifier and a second label sub-grouping identifier. The session or message corresponding to the first label sub-grouping identifier carries the first label, and the session or message corresponding to the second label sub-grouping identifier carries the second label.

In response to a trigger operation on the second grouping identifier in the grouping information window by the user, a single grouping information flow page corresponding to the second grouping identifier is displayed. The single grouping information flow page comprises each sub-grouping identifier comprised in the second grouping identifier, and the user may view the information flow corresponding to each sub-grouping identifier in the single grouping information flow page. For example, in a single grouping information flow page corresponding to the label grouping identifier shown in FIG. 12d, the page comprises a label grouping identifier, 6 unread messages and sub-grouping identifiers (a first label and a second label). The user may view a session or a message corresponding to each sub-group identifier through a dropdown control corresponding to the sub-group identifier.

In response to a trigger operation on the sub-grouping identifier in the grouping information window by the user, a single grouping information flow page corresponding to the sub-grouping identifier is displayed, wherein the single grouping information flow page comprises a second grouping identifier and a triggered sub-grouping identifier. For example, in a single grouping information flow page corresponding to the first label shown in FIG. 12e, the page comprises a label grouping identifier, 3 unread messages, a first label and two sessions corresponding to the first label.

In one embodiment of the present disclosure, when there are unread messages in one or more sessions with unclosed message notifications corresponding to a second grouping identifier, the grouping information window displays the second grouping identifier and the sub-grouping identifiers corresponding to one or more sessions with unclosed message notifications in a highlighted manner, and displays the number of unread messages. Wherein, the highlighted manner may comprise highlighted display or bold display. For a session with an unclosed message notification, it is indicated that the user wants to obtain a message in the session in time; therefore, when there are unread messages, the second grouping identifier and the sub-group identifier are displayed in a highlighted manner, and the number of unread messages is displayed at the same time, so as to attract the attention of the user and further allow that the user may view unread messages in time.

In one embodiment of the present disclosure, when there are unread messages in one or more sessions with closed message notifications corresponding to a second grouping identifier, the message grouping window displays the second grouping identifier and the sub-grouping identifiers corresponding to one or more sessions with closed message notifications in a highlighted manner, but does not display the number of unread messages. For a session with a closed message notification, it is indicated that the user does not want to be disturbed by a message in the session, so that only the second grouping identifier and a corresponding sub-grouping are highlighted, but the number of unread messages is not displayed.

Based on the above-described method embodiments, the embodiment of the present disclosure provides a session processing apparatus, which will be described below in conjunction with the accompanying drawings.

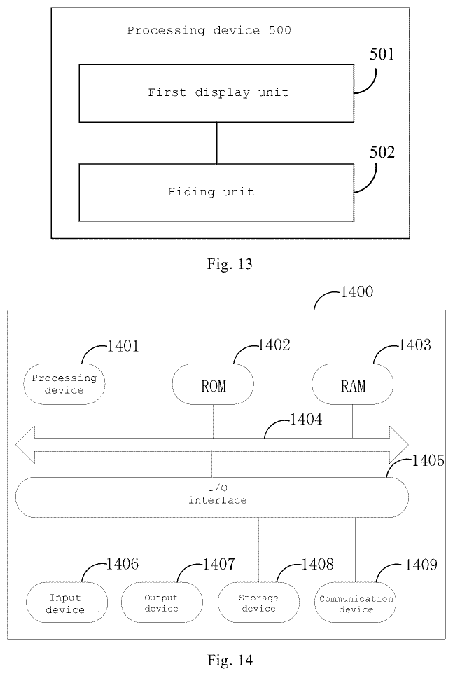

Referring to FIG. 13, which is a structural view of a session processing apparatus provided by an embodiment of the present disclosure, as shown in FIG. 13, the apparatus 500 may comprise: a first display unit 501 and a hiding unit 502.

Wherein, the first display unit 501 is configured to display a grouping information window in response to a first trigger operation in a first page of a messaging client by the user; the grouping information window is used to filter an information flow, and the information flow filtered through the grouping information window comprises one or two of a session or a message.

The hiding unit 502 is configured to hide the grouping information window in response to a second trigger operation by the user.

In one alternative implementation, the hiding unit 502 is specifically configured to hide the grouping information window and display the first page in response to triggering an operation to hide the grouping information window by the user.

In one alternative implementation, the grouping information window comprises at least two grouping identifiers, wherein the at least two grouping identifiers correspond to different filtering conditions respectively; the hiding unit 502 is specifically configured to hide the grouping information window and display an information flow page corresponding to a triggered grouping identifier in response to a trigger operation on one of the at least two grouping identifiers by the user, and the information flow page displays an information flow filtered based on a corresponding filtering condition.

In one alternative implementation, the first page comprises an information flow page corresponding to a grouping identifier.

In one alternative implementation, the grouping information window is displayed in the form of a sidebar.

In one alternative implementation, the first display unit 501 is specifically configured to pull out a grouping information window from a left edge or a right edge of the first page in response to a first operation triggered by the user in the first page of the messaging client.

In one alternative implementation, the pop-up grouping information window elbows a part of the first page out of the display interface.

In one alternative implementation, the first display unit 501 is specifically configured to display a grouping information window in response to a side slide operation triggered by the user in the first page of the messaging client; or display a grouping information window in response to a trigger operation on a menu control in the first page of the messaging client by the user, wherein the menu control is used to awaken a grouping information window.

In one alternative implementation, the triggered grouping identifier is a first grouping identifier; the information flow page is a multiple grouping information flow page, and the multiple grouping information flow page comprises a grouping identifier area and an information flow area, wherein the grouping identifier area displays at least two first grouping identifiers, and the information flow area displays an information flow corresponding to a selected first grouping identifier among the at least two first grouping identifiers; wherein, the first grouping identifier refers to a grouping identifier displayed on the multiple grouping information flow page.

In one alternative implementation, when the user enters the messaging client, the multiple grouping information flow page is displayed by default. Wherein, the multiple grouping information flow page comprises a grouping identifier area and an information flow area, wherein the grouping identifier area displays at least two first grouping identifiers, and the information flow area displays an information flow corresponding to a selected first grouping identifier among the at least two first grouping identifiers; wherein, the first page comprises the multiple grouping information flow page.

In one alternative implementation, the information flow page is a single grouping information flow page, and the single grouping information flow page displays a corresponding grouping identifier and an information flow corresponding to the grouping identifier.

In one alternative implementation, the apparatus further comprises: a second display unit.

The second display unit is configured to display a multiple grouping information flow page in response to a closing operation triggered by the user on the single grouping information flow page.

In one alternative implementation, a grouping identifier in the single grouping information flow page is different from a first grouping identifier in the multiple grouping information flow page.

In one alternative implementation, the grouping information window further comprises an editing control configured to edit the grouping information in the grouping information window; the editing the grouping information in the grouping information window comprises one or more of the following: adding a grouping identifier; deleting a grouping identifier; modifying a grouping identifier; and sorting a current grouping identifier.

In one alternative implementation, the at least two group identifiers comprise a second group identifier with a sub-group identifier, and the grouping information window displays the second group identifier and its sub-group identifiers in a secondary structure.

In one alternative implementation, when there are unread messages in one or more sessions with unclosed message notifications corresponding to a second grouping identifier, the grouping information window displays the second grouping identifier and sub-grouping identifiers corresponding to the one or more sessions with unclosed message notifications in a highlighted manner, and displays the number of unread messages; when there are unread messages in one or more sessions with closed message notifications corresponding to a second grouping identifier, the message grouping window displays the second grouping identifier and sub-group identifiers corresponding to the one or more sessions with closed message notifications in a highlighted manner, but does not display the number of unread messages.

In one alternative implementation, in the grouping information window, if there are unread messages in a session corresponding to a grouping identifier, the grouping identifier is displayed in a highlighted manner and/or the number of unread messages is displayed.

In one alternative implementation, in response to the user being a multiple organization user, the grouping information window further comprises a plurality of organization information corresponding to the user; the organization to which the user belongs may be switched by triggering the plurality of organization information.

In one alternative implementation, the grouping information window further comprises an adding control configured to add new organization information corresponding to the user.

It is to be noted that, reference may be made to the relevant descriptions in the above-described method embodiments for the specific implementations of each unit in this embodiment. The division of units in the embodiment of the present disclosure which is schematic, is only a logical function division, and there may be another division method in actual implementation. Each functional unit in the embodiment of the present disclosure may be integrated into one processing unit; alternatively, each unit may be present physically alone, or two or more units may also be integrated into one unit. For example, in the above-described embodiments, the processing unit and the sending unit may be the same unit or different units. The above-described integrated units can be implemented in the form of hardware, or implemented in the form of functional units of software.

Referring to FIG. 14, a schematic structural view of an electronic apparatus 600 suitable for implementing the embodiment of the present disclosure is shown. The terminal device in an embodiment of the present disclosure may comprise, but is not limited to, mobile terminals such as mobile phones, notebook computers, digital broadcast receivers, PDAs (personal digital assistants), PADs (pad computers), PMP (Portable Multimedia Player) and in-vehicle terminals (for example, in-vehicle navigation terminals); and fixed terminals such as digital TVs, desktop computers and the like. The electronic device shown in FIG. 14 which is only an example, shall not limit the functions and application range of the embodiments of the present disclosure.

As shown in FIG. 14, the electronic device 1400 may comprise a processing device (for example, a central processing unit, a graphic processor, and the like) 1401, which may perform various suitable actions and processing according to a program stored in a Read-only Memory (ROM) 1402 or a program loaded from a storage device 1408 into a Random Access Memory (RAM) 1403. In the RAM 1403, various programs and data required for the operation of the electronic device 1400 are also stored. The processing device 1401, the ROM 1402 and the RAM 1403 are connected to each other through a bus 1404. The input/output (I/O) interface 1405 is also connected to the bus 1404.

Generally, the following devices may be connected to the I/O interface 1405: an input device 1406 comprising, for example, a touch screen, a touch pad, a keyboard, a mouse, a camera, a microphone, an accelerometer, a gyroscope, and the like; an output device 1407 comprising, for example, a Liquid Crystal Display (LCD), a speaker, a vibrator, and the like; a storage device 1408 comprising, for example, a magnetic tape, a hard disk, and the like; and a communication device 1409. The communication device 1409 may allow the electronic device 1400 to be in wireless or wired communication with other devices to exchange data. Although FIG. 14 displays the electronic device 1400 with various devices, it should be understood that there is no requirement to implement or have all the devices shown. It is possible to alternatively implement or possess more or less devices.

In particular, according to an embodiment of the present disclosure, the process described above with reference to the flowchart may be implemented as a computer software program. For example, in an embodiment of the present disclosure, there comprises a computer program product, which comprises a computer program carried on a non-transient computer-readable medium, wherein the computer program contains program codes for executing the method shown in the flowchart. In such embodiment, the computer program may be downloaded and installed from the network through the communication device 1409, or installed from the storage device 1408, or installed from the ROM 1402. When the computer program is executed by the processing device 1401, the above-described functions defined in the method of the embodiment of the present disclosure are performed.

The electronic device provided by the embodiment of the present disclosure pertains to the same inventive concept as the method provided by the above-described embodiments, and reference may be made to the above-described embodiments for the technical details that are not elaborated in this embodiment. Moreover, this embodiment has the same beneficial effects as the above-described embodiments.

In the embodiment of the present embodiment, a computer storage medium is provided, which has a computer program stored thereon that, when executed by a processor, implements the method provided in the above-described embodiments.

It is to be noted that, the above-described computer-readable medium of the present disclosure may be a computer-readable signal medium, a computer-readable storage medium or any combination thereof. The computer-readable storage medium may be, for example, but is not limited to: an electrical, magnetic, optical, electromagnetic, infrared, or semiconductor system, device, or apparatus, or a combination thereof. More specific examples of the computer-readable storage medium may comprise, but is not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium that contains or stores a program which may be used by an instruction execution system, apparatus, or device or used in combination therewith. In the present disclosure, the computer-readable signal medium may comprise a data signal propagated in a baseband or as a part of a carrier wave, wherein a computer-readable program code is carried. Such propagated data signal may take many forms, comprising but not limited to an electromagnetic signal, an optical signal, or any suitable combination thereof. The computer-readable signal medium may also be any computer-readable medium other than the computer-readable storage medium. The computer-readable signal medium may send, propagate, or transmit a program for use by an instruction execution system, apparatus, or device or in combination with therewith. The program code contained on the computer-readable medium may be transmitted by any suitable medium, comprising but not limited to: a wire, an optical cable, radio frequency (RF), and the like, or any suitable combination thereof.

In some embodiments, the client and the server may communicate using any currently known or future developed network protocol such as HTTP (Hyper Text Transfer Protocol), and may be interconnected with digital data communication in any form or medium (for example, communication network). Examples of communication networks comprise a Local Area Network (“LAN”), a Wide Area Network (“WAN”), an extranet (for example, Internet) and an end-to-end network (for example, an ad hoc end-to-end network), as well as any currently known or future developed network.

The above-described computer-readable medium may be comprised in the above-described electronic device; or may also exist alone without being assembled into the electronic device.

The above-described computer-readable medium carries one or more programs that, when executed by the electronic device, cause that the electronic device may perform the above-described method.

The computer program code for performing the operations of the present disclosure may be written in one or more programming languages or a combination thereof, wherein the above-described programming languages comprise but are not limited to object-oriented programming languages, such as Java, Smalltalk, and C++, and also comprise conventional procedural programming languages, such as “C” language or similar programming languages. The program code may be executed entirely on the user's computer, partly on the user's computer, executed as an independent software package, partly on the user's computer and partly executed on a remote computer, or entirely executed on the remote computer or server. In the case of a remote computer, the remote computer may be connected to the user's computer through any kind of network (comprising a local area network (LAN) or a wide area network (WAN)), or may be connected to an external computer (for example, connected through Internet using an Internet service provider).

The flowcharts and block views in the accompanying drawings illustrate the possibly implemented architectures, functions, and operations of the system, method, and computer program product according to various embodiments of the present disclosure. In this regard, each block in the flowchart or block view may represent a module, a program segment, or a part of code, wherein the module, the program segment, or the part of code contains one or more executable instructions for realizing a specified logic function. It should also be noted that, in some alternative implementations, the functions marked in the block may also occur in a different order from the order marked in the accompanying drawings. For example, two blocks shown in succession which may actually be executed substantially in parallel, may sometimes also be executed in a reverse order, depending on the functions involved. It should also be noted that each block in the block view and/or flowchart, and a combination of the blocks in the block view and/or flowchart, may be implemented by a dedicated hardware-based system that performs the specified functions or operations, or may be implemented by a combination of dedicated hardware and computer instructions.

The units involved in the described embodiments of the present disclosure may be implemented in software or hardware. Wherein, the names of the units/modules do not constitute a limitation on the units themselves under a certain circumstance.

The functions described hereinabove may be performed at least in part by one or more hardware logic components. For example, without limitation, the hardware logic components of a demonstrative type that may be used comprise: a Field Programmable Gate Array (FPGA), an Application Specific Integrated Circuit (ASIC), an Application Specific Standard Product (ASSP), a System on Chip (SOC), a Complex Programmable Logical device (CPLD) and the like.

In the context of the present disclosure, a machine-readable medium may be a tangible medium, which may contain or store a program for use by the instruction execution system, apparatus, or device or use in combination with the instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus, or device, or any suitable combination thereof. More specific examples of the machine-readable storage medium may comprise an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

It is to be noted that, various embodiments in this specification are described in a progressive manner, so that differences from other embodiments are mainly illustrated in each embodiment, and reference may be made to each other for the same or similar parts between various embodiments. As for the system or apparatus disclosed in the embodiments, since it corresponds to the method disclosed in the embodiments, the descriptions are relatively simple; for relevant parts, reference may be made to some descriptions of the method.

It should be understood that, in the present application, “at least one (item)” means one or more, and “a plurality of” means two or more. The term “and/or” is used to describe an associated relationship of associated objects, which means that there may be three relationships, for example, “A and/or B”, which may mean such three circumstances as A present alone, B present alone, and A and B present at the same time, wherein A and B may be singular or plural. The character “/” herein generally indicates that the contextual associated objects are in an “or” relationship. “At least one of the following (items)” or its similar expression refers to any combination of these items, comprising any combination of singular (items) or plural (items). For example, at least one of a, b or c may mean: a, b, c; “a and b”, “a and c”, “b and c”, or “a and b and c”, where a, b and c may be single or multiple.

It is also to be noted that, the relational terms such as first and second herein are only used to distinguish one entity or operation from another entity or operation, but do not necessarily require or imply any such actual relationship or sequence present between these entities or operations. Moreover, the terms “comprising”, “including” or any other variation thereof are intended to cover non-exclusive inclusions, so that a process, method, article or device comprising a series of elements comprises not only those elements, but also other elements not explicitly listed or elements inherent to such process, method, article or device. In the case where there are no more restrictions, an element defined by the phrase “comprising one . . . ” does not exclude an additional identical element also present in the process, method, article or device comprising the element.

The steps of the method or algorithm described in conjunction with the embodiments disclosed herein may be directly implemented in hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable disk, a CD-ROM, or any other form of storage medium known in the art.

The above-described description of the disclosed embodiments enables those skilled in the art to realize or use the present application. Multiple modifications to these embodiments will be obvious for those skilled in the art, and the general principles defined herein can be implement in other embodiments without departing from the spirit or scope of the present application. Therefore, the present application will not be limited to these embodiments shown herein, but intended to conform to the broadest scope consistent with the principles and novel features disclosed herein.

1. An information processing method comprising:
displaying a multiple grouping information flow page; the multiple grouping information flow page comprises a grouping identifier area and an information flow area, wherein the grouping identifier area displays at least two first grouping identifiers, and the information flow area displays an information flow corresponding to a selected first grouping identifier among the at least two first grouping identifiers; and
displaying a single grouping information flow page in response to a first preset operation triggered by a user; the single grouping information flow page displays a corresponding grouping identifier and a corresponding information flow.

2. The method according to claim 1, wherein a grouping identifier corresponding to the single grouping information flow page is different from the at least two first grouping identifiers in a multiple grouping information flow page.

3. The method according to claim 1, wherein the method further comprises:
switching from the single grouping information flow page to a multiple grouping information flow page in response to a second preset operation triggered by the user.

4. The method according to claim 3, wherein the switching from the single grouping information flow page to a multiple grouping information flow page in response to a second preset operation triggered by the user comprises:
displaying a multiple grouping information flow page in response to a closing operation triggered by the user on the single grouping information flow page;
or,
displaying a grouping information window in response to a third preset operation triggered by the user, wherein the grouping information window displays a plurality of grouping identifiers comprising the at least two first grouping identifiers; and displaying a multiple grouping information flow page in response to a trigger operation on one of the at least two first grouping identifiers in the grouping information window by the user.

5. The method according to claim 4, wherein,
displaying a first control in the single grouping information flow page, wherein the first control displays a grouping identifier and a closing identifier corresponding to the single grouping information flow page;
the closing operation triggered by the user on the single grouping information flow page comprises: triggering a closing identifier in the first control by the user.

6. The method according to claim 1, wherein the displaying a single grouping information flow page in response to a first preset operation triggered by the user comprises:
displaying a grouping information window in response to a grouping information window awakening operation triggered by the user, wherein the grouping information window comprises the at least two first grouping identifiers and other grouping identifiers; and
displaying a single grouping information flow page corresponding to the grouping identifier in response to a trigger operation on any of the other grouping identifiers by the user.

7. The method according to claim 6, wherein the displaying a grouping information window in response to a grouping information window awakening operation triggered by the user comprises:
displaying a grouping information window in response to a side slide operation triggered by the user in the multiple grouping information flow page; or,
displaying a grouping information window in response to a trigger operation on a menu control in the multiple grouping information flow page by the user.

8. The method according to claim 7, wherein the method further comprises:
displaying the multiple grouping information flow page in response to that the user uses a messaging client for the first time and a number of the sessions with unread messages in the messaging client reaches a preset number threshold.

9. The method according to claim 1, wherein the at least two first grouping identifiers comprise: a message grouping identifier and an unread grouping identifier,
or,
the method further comprises one or more of the following:
displaying a number of unread messages in a corresponding session correspondingly according to each first grouping identifier in the multiple grouping information flow page; and
displaying the number of unread messages in a corresponding session correspondingly according to its grouping identifier in the single grouping information flow page.

10. (canceled)

11. The method according to claim 1, wherein,
at least two first grouping identifiers in the multiple grouping information flow page are uniformly set by the system;
or,
the method further comprises: receiving a first grouping identifier setting operation by the user, and determining the at least two first grouping identifiers in the multiple grouping information flow page according to the first grouping identifier setting operation.

12. The method according to claim 4, wherein the method further comprises one or more of the following:
the grouping information window comprises an editing control configured to edit the grouping information in the grouping information window;
in the grouping information window, if there are unread messages in a session corresponding to a grouping identifier, the grouping identifier is displayed in a highlighted manner and/or a number of unread messages is displayed; and
the grouping information window also comprises a plurality of organization information corresponding to the user; and the organization to which the user belongs may be switched by triggering the plurality of organization information.

13. An information processing method, comprising:
displaying a single grouping information flow page; the single grouping information flow page displays a corresponding grouping identifier and a corresponding information flow;
displaying a multiple grouping information flow page in response to a second preset operation triggered by a user; the multiple grouping information flow page comprises a grouping identifier area and an information flow area, wherein the grouping identifier area displays at least two first grouping identifiers, and the information flow area displays an information flow corresponding to a selected first grouping identifier among the at least two first grouping identifiers.

14. The method according to claim 13, wherein a grouping identifier corresponding to the single grouping information flow page is different from the at least two first grouping identifiers in a multiple grouping information flow page.

15. The method according to claim 13, wherein the displaying a multiple grouping information flow page in response to a second preset operation triggered by the user comprises:
displaying a multiple grouping information flow page in response to a closing operation triggered by the user on the single grouping information flow page;
or,
displaying a grouping information window in response to a grouping information window awakening operation triggered by the user, wherein the grouping information window displays a plurality of grouping identifiers comprising the at least two first grouping identifiers; displaying a multiple grouping information flow page in response to a trigger operation on one of the at least two first grouping identifiers in the grouping information window by the user.

16. The method according to claim 15, wherein the single grouping information flow page displays a first control, and the first control displays a grouping identifier and a closing identifier corresponding to the single grouping information flow page;
the closing operation triggered by the user on the single grouping information flow page comprises: triggering a closing identifier in the first control by the user.

17. The method according to claim 15, wherein the displaying a grouping information window in response to a grouping information window awakening operation triggered by the user comprises:
displaying a grouping information window in response to a side slide operation triggered by the user on the single grouping information flow page; or,
displaying a grouping information window in response to a trigger operation on a menu control in the single grouping information flow page by the user.

18. An information processing method, comprising:
receiving a grouping identifier selection operation by the user; wherein different grouping identifiers correspond to different information flow filtering conditions;
displaying a multiple grouping information flow page when a grouping identifier selected by the user is a first grouping identifier; the multiple grouping information flow page comprises a grouping identifier area and an information flow area, wherein the grouping identifier area displays at least two first grouping identifiers, and the information flow area displays an information flow corresponding to a selected first grouping identifier among the at least two first grouping identifiers;
displaying a single grouping information flow page when a grouping identifier selected by the user is not a first grouping identifier; the single grouping information flow page displays a corresponding grouping identifier and an information flow corresponding to the grouping identifier.

19. The method according to claim 18, wherein the method further comprises:
switching from the multiple grouping information flow page to the single grouping information flow page in response to a current display of the multiple grouping information flow page and a first preset operation triggered by the user,
or,
switching from the single grouping information flow page to the multiple grouping information flow page in response to a current display of the single grouping information flow page and a second preset operation triggered by the user.

20-23. (canceled)

24. An electronic device comprising: a processor and a memory;
the memory is configured to store instructions or a computer program;
the processor is configured to execute the instructions or computer program in the memory, so as to cause the electronic device to perform the method according to claim 1.

25. A computer-readable storage medium, wherein the computer-readable storage medium has instructions stored thereon that, when run on a device, cause the device to perform the method according to claim 1.

26-45. (canceled)
